(19) United States
(12) Patent Application Publication
(10) Pub. No.: US 2007/0199383 A1
(43) Pub. Date: Aug. 30, 2007

(54) Pipeline Integrity Analysis Using an In-Flow Vehicle

(75) Inventors: Paul Lander, Maynard, MA (US); Philip M. Maltby, Tulsa, OK (US)

Correspondence Address: FISH & RICHARDSON P.C., P.O. BOX 1022, MINNEAPOLIS, MN, 55440-1022, US

(73) Assignee: FLOW METRIX, INC., Maynard, MA (US)

(21) Appl. No.: 11/563,489

(22) Filed: Nov. 27, 2006

Related U.S. Application Data
(60) Provisional application No. 60/739,913, filed on Nov. 28, 2005.

(51) Int. Cl. G01H 3/00; F16L 55/46; F16L 55/32; F16L 55/40

(52) U.S. Cl. 73/661

(57) ABSTRACT

Apparatus and methods for mapping vibrations in a pipeline using an in-flow vehicle (“IFV”) are provided. The IFV is propelled through a pipeline, either by fluid flow or by self-propulsion. The IFV includes one or more vibration sensors, a power source, and electronic instrumentation that is programmed to records vibrations present in the fluid periodically as the IFV travels through the pipeline. Processed vibrations are periodically stored in the memory of the vehicle and subsequently transferred to a computer. The processed vibrations are analyzed to determine the location of the vibration energies emanating from any leaks present in the pipeline.

### CROSS REFERENCE TO RELATED APPLICATION

This application claims priority to U.S. Provisional Application No. 60/739,913, which was filed Nov. 28, 2005, and is incorporated by reference.

### STATEMENT REGARDING FEDERALLY-SPONSORED RESEARCH

This invention was made with Government support under award no. DMI-0422171 awarded by the National Science Foundation. The Government has certain rights in this invention.

### TECHNICAL FIELD

The description relates to analyzing the integrity of a pipeline.

### BACKGROUND

Transmission pipeline networks regularly transport hazardous fluids and gases, such as liquid natural gas, methane, petroleum, and other hydrocarbon products. The integrity of such buried pipelines is currently tested infrequently and is usually uncertain. Leaks in transmission pipeline are hazardous and often undetected.

### SUMMARY

An In-Flow Vehicle (IFV) that can travel long distances inside a pipeline can be used to analyze the integrity of the pipeline. In a typical application, the IFV is used in a pipeline carrying a hazardous material in a liquid or gaseous state, such as, for example, petroleum, liquid propane, liquid natural gas, or methane in a gaseous state. The Fluid is typically under high pressure (200 to 2,000 pounds per square inch (psi)). The fluid is transported through the pipeline over long distances, perhaps over several thousand miles. The pipeline is designed to transport the fluid as quickly as possible, in an energy-efficient manner. Therefore, throughout the pipeline, the flow of fluid may be laminar or turbulent, and the pressure of the fluid and its flow velocity may be affected by pumps, changes in the diameter of the pipeline, or other factors.

In one implementation, the flow of the fluid in the pipeline passively conveys the IFV through the pipeline. In this mode, the IFV travels with the fluid along the length of the pipeline and does not require its own means of propulsion. The buoyancy of the IFV can be programmed by setting its weight relative to the weight of the fluid in the pipeline. The IFV is continuously guided forward through the center of the pipeline using mechanical features to harness the kinetic energy of the fluid flow through a negative feedback mechanism.

In another implementation, the IFV is fitted with a motor-driven propeller. The rotational speed of the propeller and the mass of fluid displaced by each rotation can be varied to achieve a desired velocity of the IFV through the pipeline. One application of the propulsion technique is to propel the IFV through a pipeline filled with fluid under hydrostatic pressure, such that the fluid is approximately stationary in the pipe and there is no fluid flow.

Leaks in high-pressure pipelines generate vibration energy which is propagated significant distances through the fluid in the pipeline. The IFV is fitted with instrumentation for time-keeping and for recording, processing, and storing received vibrations at periodic intervals on its journey through a pipeline in order to locate leaks.

Received vibrations include vibrations emanating from leaks, pipeline components such as pumps, and an acoustic transmitter which can be purposefully connected to the pipe in order to transmit an acoustic message to the IFV. The IFV associates vibrations received a particular time with vibrations sources at known locations on the pipeline and measured changes in gradient of the pipeline, and stores timing and other information needed to estimate the location of unknown vibration sources.

The IFV is retrieved from the pipeline at the end of its journey through the pipeline. Data stored in the IFV is transferred to a computer for analysis and graphical presentation, and for a determination of the presence and locations of any leaks in the pipeline.

The details of one or more implementations are set forth in the accompanying drawings and the description below. Other features will be apparent from the description and drawings, and from the claims.

### DESCRIPTION OF DRAWINGS

FIG. 1 is a schematic representation of a launch system for launching an IFV into a pipeline.

FIG. 2 is a schematic representation of a retrieval system for retrieving an IFV from a pipeline.

FIG. 3 is a representation of a mechanical form of an IFV having a fuselage.

FIG. 4 is a rear-view perspective of an IFV with fuselage, fins and wings.

FIG. 5 is a schematic representation of a parabolic velocity flow profile in a pipeline.

FIG. 6 is a schematic representation of flow-directing tubes mounted externally to the fuselage of an IFV.

FIG. 7 is a rear-view perspective of the IFV of FIG. 6 with a rear disc and inlets of the flow-directing tubes.

FIG. 8 is a front-view perspective of the IFV with outlets of the flow-directing tubes.

FIG. 9 is a schematic representation of an IFV with a cowling which contain flow-directing slots.

FIG. 10 is a rear-view perspective of the IFV of FIG. 9 with the cowling which contains flow-directing slots.

FIG. 11 is a representation of a hemisphere that forms part of an IFV.

FIG. 12 is a representation of a spherical IFV.

FIG. 13 is a block diagram of the elements of an electronic circuit board of an IFV.

FIG. 14 is a schematic representation of an acoustic transmitter connected to a pipeline.

FIG. 15 depicts example data stored by an IFV and transferred to a computer for analysis.

### DETAILED DESCRIPTION

Launch and Retrieval

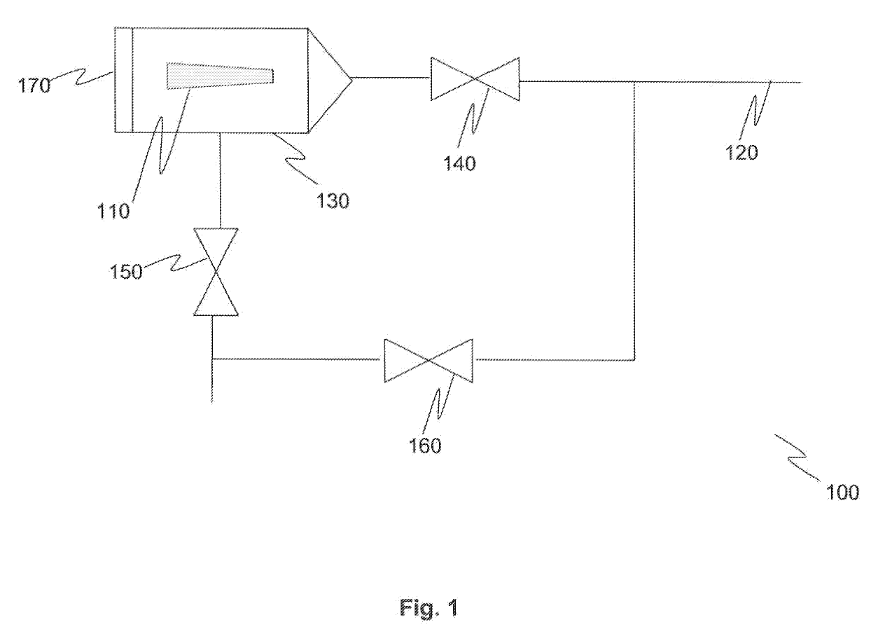

Referring to FIG. 1, one implementation of a launch system 100 for launching an IFV 110 into a main pipeline 120 includes a launcher 130 that contains an IFV before launch. Initially, a launcher isolation valve 140 and a kicker valve 150 are both closed, and a main line valve 160 is open. In this configuration, the pressure in the launcher is near atmospheric pressure. The IFV 110 is inserted into the launcher past the inlet from the kicker valve output using a launch door 170. The kicker valve 150 then is opened and the launcher is filled with fluid from the main pipeline. When the interior of the launcher is at approximately the same pressure as the main pipeline, the launcher isolation valve 140 is opened and the main line valve 160 is closed until the IFV has left the launcher and entered the main pipeline. The valves are then returned to their initial configuration prior to launch of the IFV (i.e., the launcher isolation valve 140 and the kicker valve 150 are closed and the main valve 160 is opened).

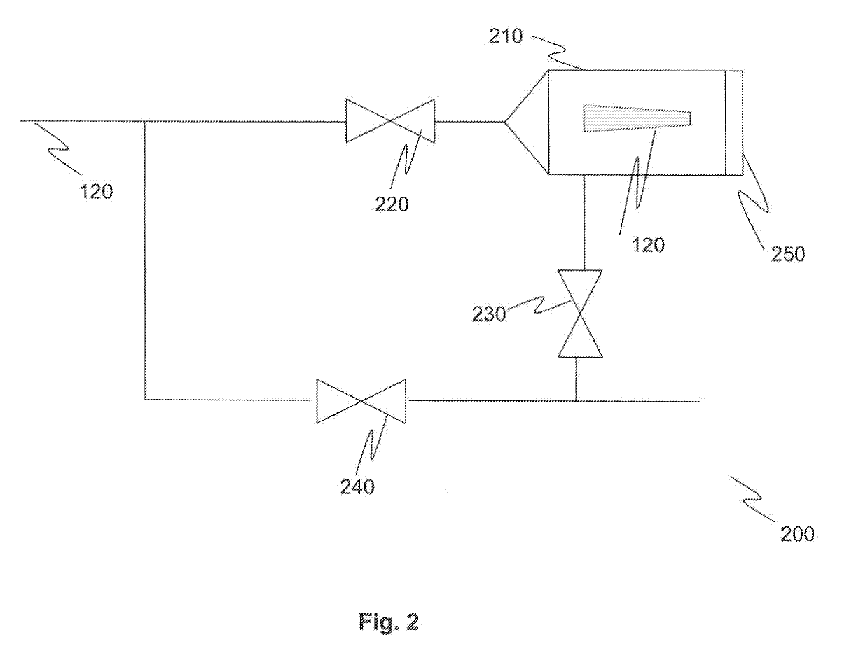

Referring to FIG. 2, one implementation of a retrieval system 200 for retrieving the IFV 110 from the main pipeline 120 includes a receiver 210 that receives the IFV 110. Initially, a receiver isolation valve 220 and a bypass valve 230 are closed, and a receiver main line valve 240 is open. In this configuration, the pressure in the receiver is near atmospheric pressure, and the interior of the receiver is isolated from the pipeline. To begin receiver operations, a receiver door 250 is closed and the receiver 210 is purged of air. Next, the receiver isolation valve 220 and the receiver bypass valve 230 are opened, and the receiver main line valve 240 is closed to force fluid from the main pipeline 120 to flow through the receiver. As a result, the IFV flows into the receiver and stops past the point where the receiver bypass valve 230 is connected to the receiver. The receiver main line valve 240 is then opened and the receiver isolation valve 220 and the receiver bypass valves 230 are closed. The receiver is then purged of fluid and the pressure inside the receiver is reduced to near atmospheric pressure. The receiver door 250 is then opened and the IFV 110 is retrieved.

Mechanical Configuration of the IFV

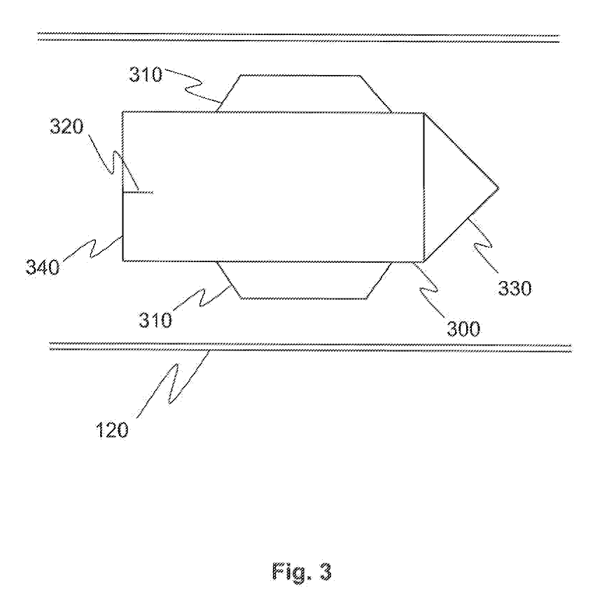

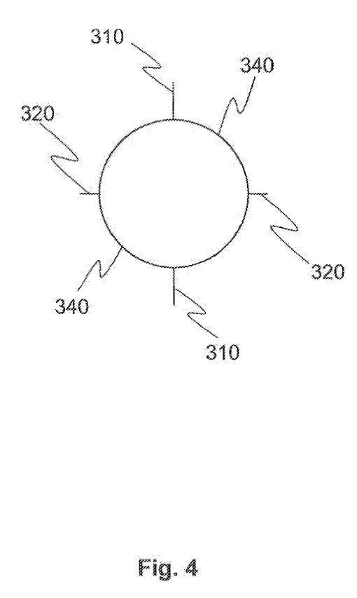

Referring to FIG. 3, in one implementation, the IFV 110 has a fuselage 300. Optional dual wings 310 and dual fins 320 help to stabilize the IFV as it is carried forward in the flow of fluid inside the pipeline 120. A forward cone 330 seals the forward part of the fuselage 300 using an O-ring and evenly spaced retaining screws. A rear disc 340 seals the rear part of the fuselage 300. The fuselage, wings, fins, forward cone and rear disc may be machined from a lightweight material with high tensile strength, such as glass-filled polycarbonate, nylon, or aluminum. FIG. 4 shows the IFV 110 from the rear-view perspective with rear disc, fins and wings.

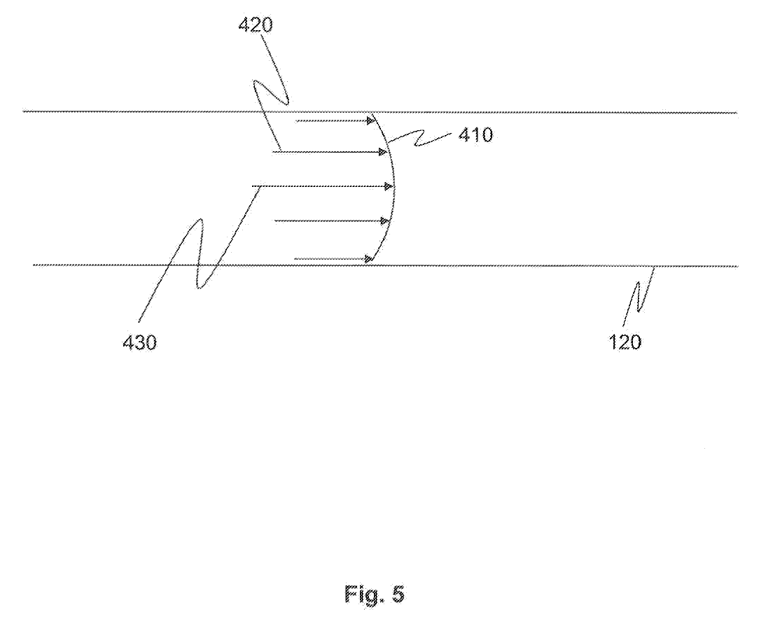

Fluid transported in a pipeline travels faster at the center of the pipe than near the pipeline walls. Referring to FIG. 5, this results in the pipeline 120 having a parabolic velocity flow profile 410. Flow velocity is represented schematically by an arrow 420, whose length is proportional to the flow velocity at a particular location relative to the center 430 of the flow. The flow velocity is maximal at the center of the flow profile (i.e., the center of the cross-sectional area of the pipe). The flow velocity is minimal at the wall of the pipe.

This known profile of velocity differences distributed throughout the cross-sectional area of the pipe can be used to create a passive guidance system for the IFV. The energy required for changing the directions—or momentum—of the IFV can be harnessed from the differences in kinetic energy of the fluid flow distributed throughout the cross-sectional area of the pipe.

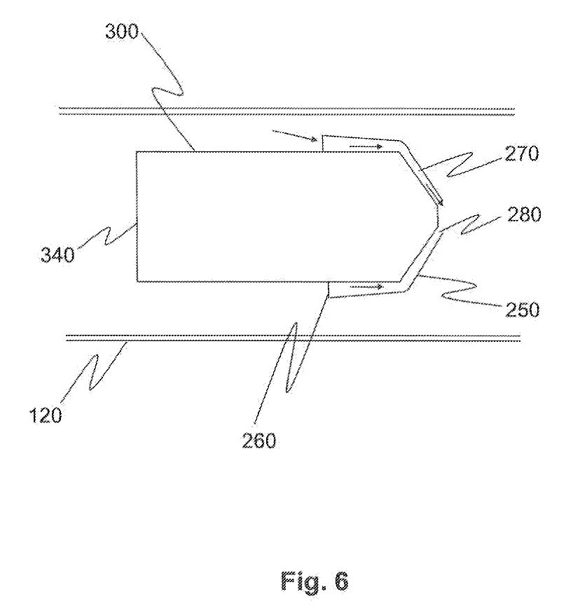

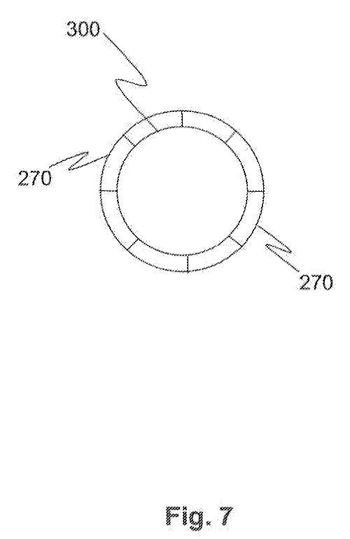

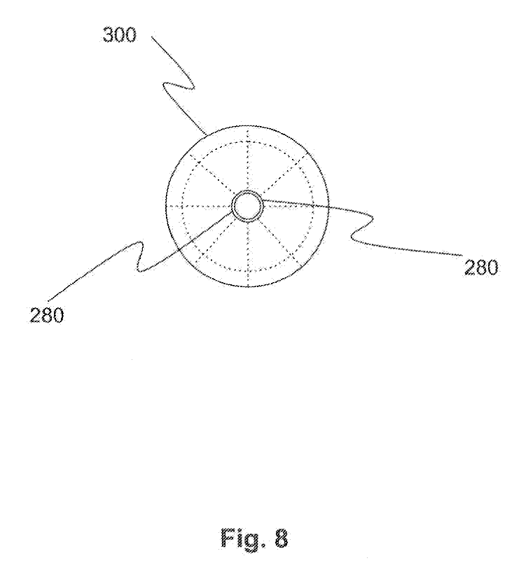

Referring to FIG. 6, in one implementation, the IFV may have one or more flow-directing tubes 250 mounted external to the fuselage 300. Each flow-directing tube has a tube inlet 260 for fluid. The tube decreases in cross-sectional area 270 along the length of the tube, such that fluid is accelerated through the tube before the fluid is discharged at the tube outlet 280. A number of flow-directing tubes 250 are arranged symmetrically around the circumference of the fuselage 300. FIG. 7 shows the IFV from the rear-view perspective with a rear disc and the inlets 260 of the flow-directing tubes, and FIG. 8 shows the IFV from the front-view perspective with the tube outlets 280 and the fuselage 300.

If the fuselage is not traveling exactly parallel to the walls of the pipe (i.e., through the center of the cross-sectional area of the pipe), the velocities of fluid flowing through the flow-directing tubes will not be the same, due to the parabolic velocity flow profile 410. As a result, the IFV will experience an angular frictional drag. In particular, a net force is created by the differing rates of fluid discharged from the tube outlets 280. The vector of this net force acts so as to re-align the IFV to be parallel to the walls of the pipe and centered in the cross-sectional area of the pipe. The continuous realignment of the IFV to the center of flow is a negative feedback mechanism that automatically and continuously corrects the course of the IFV. The IFV is guided forward through the center of the pipeline with no energy source other than the kinetic energy of the fluid.

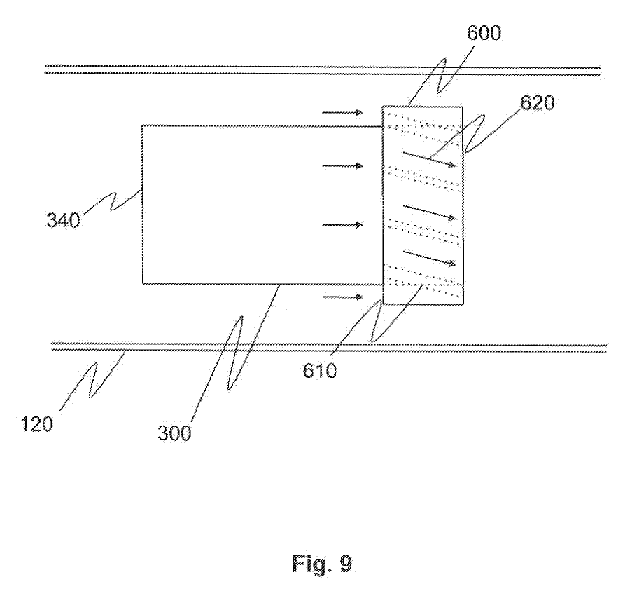

Referring to FIG. 9, in one implementation, the IFV may have a cowling 600 fitted to the fuselage 300 and the towards the front of the IFV. The cowling is arranged so as to encircle the fuselage. Flow-directing slots 610 are cut into the cowling at regular intervals around the circumference of the cowling. The flow-directing slots direct fluid at a preset vector 620 past the IFV.

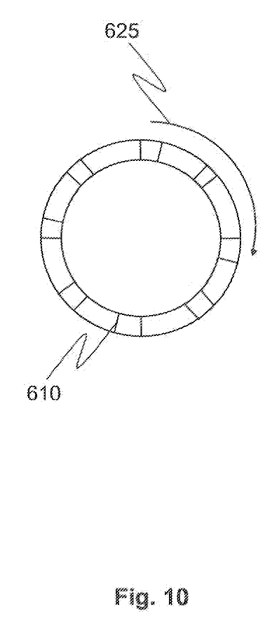

Referring to FIG. 10, the passage of fluid from the flow-directing slots 610 creates a turning force 625 that causes the IFV to spin so as to guide the IFV forward through the center of the pipeline with no energy source other than the kinetic energy of the fluid.

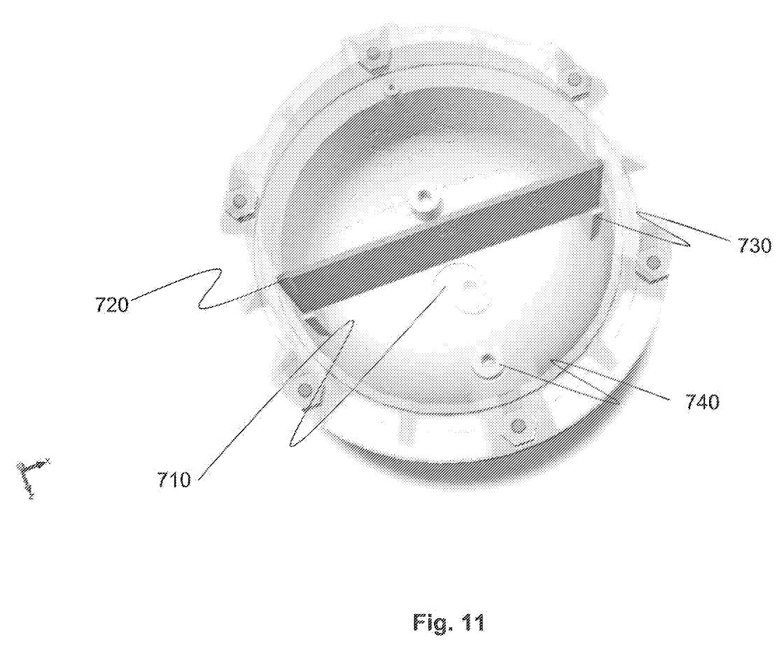

Referring to FIG. 11, in one implementation, the IFV is constructed from two substantially similar hemispherical housing components 700. One or more vibration sensors 710 are mounted to the interior wall of the hemisphere. An electronic circuit board 720 is securely mounted in the hemisphere using slots 730. One or more threaded inserts 740 are molded into the interior wall of the hemisphere. These inserts accept steel rods which can be inserted which can be inserted in order to add weight to the IFV so as to set the buoyancy of the IFV for a fluid of known weight. The weight of the rods is distributed evenly about the centroid of the sphere created when the 2 hemispheres are fitted together.

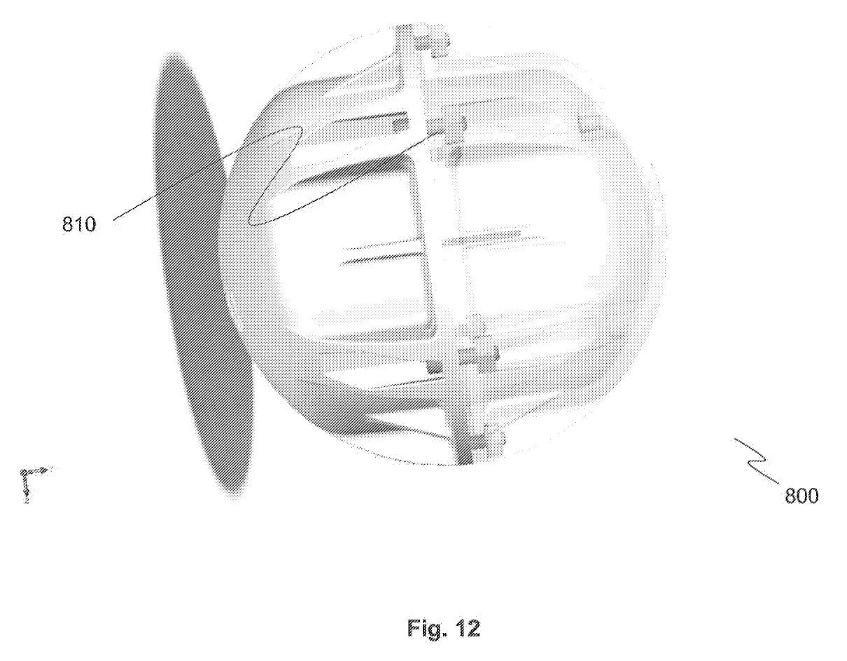

Referring to FIG. 12, the IFV is a sphere 800 when the two hemispherical components are fitted together with hex screws 810 spaced regularly around the circumference of the sphere. An O ring seals the IFV sphere 800.

Guidance and Buoyancy

In one implementation, the weight of the IFV is adjusted so that the IFV has neutral buoyancy. That is, the IFV displaces approximately its own mass of fluid under the effects of gravity. The weight of the IFV is adjusted to achieve neutral buoyancy based on the specific gravity of the fluid in the pipeline.

Referring again to FIG. 4, the pipeline 120 normally has a parabolic velocity flow profile 410. The flow velocity is maximal at the center of the flow profile and minimal at the wall of the pipe. Therefore, at points away from the center of the pipe, the IFV will experience a pressure differential based on the difference in flow velocity and depending on the position of the IFV in the flow profile. As a result, the IFV will experience a net force, based on a drag proportional to the difference in velocity at the center of the flow profile and elsewhere. This force will tend to direct the IFV towards the center of the flow profile. The resistance of the IFV to this force is negligible since the fluid in the pipe offers no resistance to shear stress and the surface of IFV sphere minimizes frictional losses. The IFV may spin as it travels in the fluid. However, the IFV experiences almost no acceleration against its walls. The internal vibration sensor therefore registers almost no signal due to the passage of the IFV through the pipeline. This benefits operation of the IFV significantly, since the sensors will react almost exclusively to vibrations in the fluid from external sources and not from the motion of the IFV itself.

The profile of velocity differences distributed throughout the cross-sectional area of the pipe provides a mechanism for achieving a passive guidance system for the spherical IFV. The trajectory of the IFV is maintained in the center of the flow with course corrections achieved using only the energy of the fluid flow.

In another implementation, the weight of the IFV is adjusted to achieve negative buoyancy. That is, the IFV may be weighted to be more dense than the fluid in the pipe. With negative buoyancy, the IFV will roll along the bottom of the pipe and will be conveyed through the pipeline by the fluid flow. The velocity at which the IFV is propagated will be less than in the center of the flow, due to the reduced velocity of fluid flow at the pipe wall and frictional losses associated with rolling. Propagation under conditions of negative buoyancy may be advantageous in pipelines carrying very light fluids or gases, for example, natural gas.

In another implementation, the weight of the IFV is adjusted to achieve positive buoyancy. That is, the IFV is less dense than the fluid in the pipe. With positive buoyancy, the IFV will roll along the top of the pipe and will be conveyed through the pipeline by the fluid flow. As with the case of negative buoyancy, the velocity at which the IFV is propagated rolling along the top of the pipeline will be less than in the center of the flow. Propagation under conditions of positive buoyancy may be advantageous in pipelines carrying heavy fluids, such as, for example, crude oil.

Electronics and Power Management

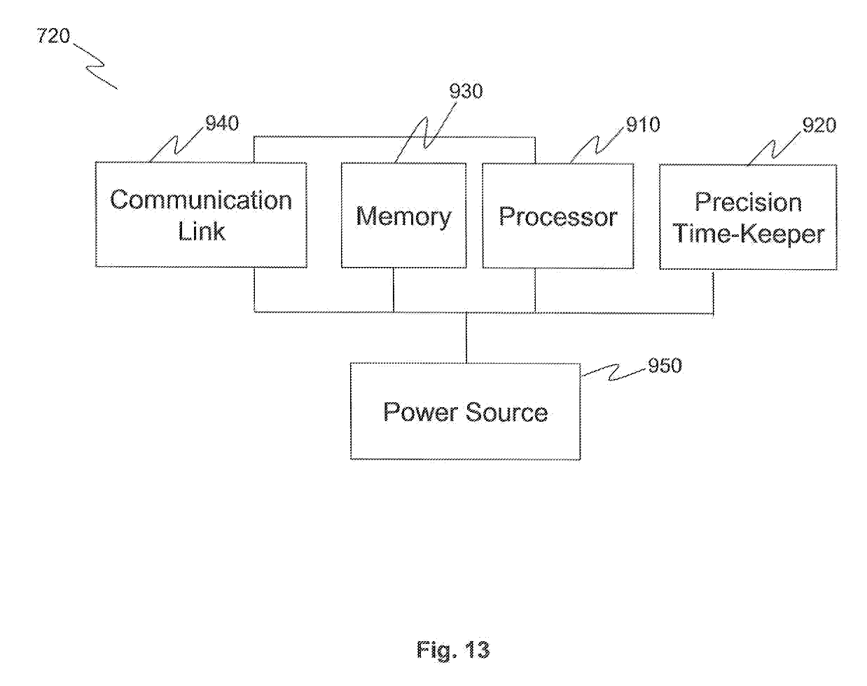

The fuselage contains the electronic circuit board and power source. Referring to FIG. 13, the electronic circuit board 720 is managed by a processor 910. A precision time-keeper 920 allows the processor to make vibration recordings from one or more vibration sensors 710 connected to the IFV 800. Vibration recordings are processed by the processor and the processed vibrations may be stored in memory 930.

A communication link 940 allows the processed vibrations stored in memory to be transferred to a computer. In one implementation, the communication link is a radio that allows communication of data to a computer from within a sealed IFV. A receiving radio that is compatible with the radio in the IFV is connected to the computer.

In another implementation, the communication link is a Universal Serial Bus (USB) connection port.

The electronic circuit board receives power from a power source 950. In one implementation, the power source is a lithium primary battery that is not rechargeable, and that provides sufficient power to allow a hermetically sealed IFV to record vibrations for at least several months or longer.

Energy Gathering Mechanism

The IFV may usefully generate electrical power as it travels through a pipeline. Electrical power is generated by converting the kinetic energy associated with the motion of the IFV. In one implementation, the IFV has a spherical housing that exhibits a tendency to rotate as it travels through the pipeline. Some of the mechanical energy from this motion can be converted to electrical power by several mechanisms.

In one implementation, the IFV contains a magnet placed inside a coil such that the magnet will move through the coil as the IFV rotates, causing an alternating electrical current to be generated in the coil. The alternating electrical current is then rectified to produce direct current using well-known rectification techniques. The direct current can be used to power the electronics of the IFV directly or it can be used to store electrical energy in, for example, a capacitor or a battery for future use.

In another implementation, the IFV contains a piece of piezoelectric material, such as a strip of polyvinylidene fluoride (“PVDF”) film, which has a weight affixed to one end. As the IFV rotates the PVDF film mechanically flexes due to gravitational and rotational acceleration of the weight. The PVDF film outputs an electrical current in response to the flexure. The output electrical current is then rectified and used either immediately or subsequently to power the electronics of the IFV.

Transmitting an Acoustic Message

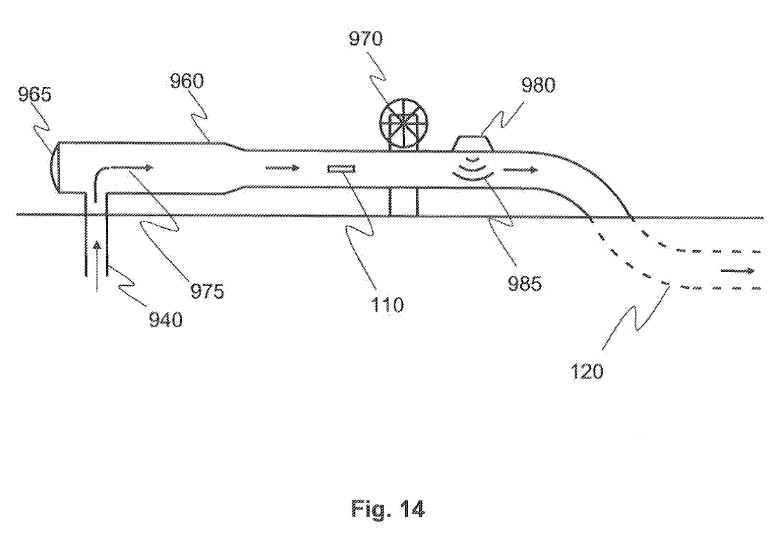

Referring to FIG. 14, an IFV 110 is loaded into a launcher barrel 960 via a launcher door 965. After the launcher door has been closed, a gate valve 970 is opened. Fluid 975 is introduced into the launcher via an inlet 940, and the flow of fluid 975 carries the IFV past the gate valve and into the main pipeline 120. An acoustic transmitter 980, which is in contact with the pipeline, transmits a vibration 985 onto the pipeline and into the fluid in the pipeline. The transmitted vibration 985 is received by the IFV 110. The IFV can respond to the transmitted vibration by storing a value of its time-keeper 920 in memory 930, together with a measure of the received vibration at this time. The IFV is thereby able to record the value of the time-keeper at approximately the start of the journey through the pipeline. The IFV can also record the particular form of received vibration, as this may be useful subsequently, such as, for example, to recall the date, time, geographical location, pipeline characteristic, or other useful information at the start of the journey.

One or more acoustic transmitters can be positioned at various points along the pipeline. The IFV can be programmed to receive transmitted vibrations at any time during the journey through the pipeline. The transmitted vibrations can be arranged in a pattern so that each unique pattern represents a particular acoustic message. The IFV then responds in a pre-programmed manner to the particular acoustic message received. Examples of the acoustic messages include an instruction to store the value of the time-keeper, to set a value of the time-keeper, to start recording vibrations, or to stop recording vibrations. This means of communication from the exterior to the interior of the pipeline is of general usefulness and the utility of other forms of acoustic messages in apparent.

In one implementation, two acoustic transmitters are connected to the pipeline and are used to define the duration of the journey of the IFV through the pipeline. The first acoustic transmitter is located at approximately the start of the pipeline and the second acoustic transmitter is located at approximately the end of the pipeline. The IFV receives an acoustic message from the first acoustic transmitter. The IFV responds by starting to record vibrations and by storing the value of the IFV's time-keeper in memory at approximately the start of the journey through the pipeline. The IFV subsequently receives an acoustic message from the second acoustic transmitter. the IFV responds by stopping the recording of vibrations and storing in memory the value of the IFV's time-keeper at approximately the end of the journey through the pipeline.

Vibration Sensing, Recording, and Processing

At approximately the launch time, the processor of the IFV starts to record vibration data at programmed intervals. The condition to start recording may be based on a pre-programmed value of the time-keeper, receiving an acoustic message, or some other event. The IFV can store the value of the time-keeper when the IFV starts to record vibration data.

A recording, xₖ(n), consists of a number of digitized samples, n=1 to N, made at time k. The recording may usefully be filtered to isolate particular frequency components of the recorded signal. The filter of length Q may take the general form of:

$$y ( n ) = {\sum }_{i = 0}^{l - Q} a ( i ) y ( n - i ) + b ( i ) x ( n - i )$$

The coefficients of the filter, a and b, may be designed using well-known design methods. One or more filtered signals, yₖ(n), can be obtained at time k from the recorded signal, xₖ(n). The filtered signal may include different components of the vibrations present in the pressurized pipe medium, such as vibrations from a leak. Filtered vibrations from a pump or other pipeline components can be used to relate a landmark of the pipeline and determine a location of the IFV at a particular value of its time-keeper.

A low-frequency filtered signal may be used to estimate the degree of tilt of the IFV, which can be used as an estimate of the gradient of the pipeline. A series of recordings of the tilt signal may be compared with a topographic map of the pipeline to determine a location of the IFV at a particular value of its time-keeper.

The filtered signal may also be used to detect and receive an acoustic message transmitted by an acoustic transmitter 980 connected to the pipeline.

The filtered signal is also useful for removing or canceling the effects of unwanted vibrations. If the filtered signal, yₖ(n), contains the energy of an unwanted vibration, the unwanted vibration can be subtracted from the recorded signal, xₖ(n), to leave the desired signal, zₖ(n):
zₖ(n)=xₖ(n)−yₖ(n)

Other approaches to cancellation of unwanted vibrations are possible, including the well-known technique of adaptive cancellation using vibration recordings from two or more sensors.

A series of original or processed vibration recordings (that is, xₖ(n), yₖ(n), or zₖ(n)) recorded at discrete times k=1 to K form a record of the vibrations recorded periodically during the journey of the IFV through the pipeline. Particular processed values of the recording can be saved at regular intervals or when an event of interest is detected. Values saved in memory at regular intervals, including at every recording interval or less frequently, can usefully represent the vibrations present during the journey. The memory requirements of the IFV can be reduced by saving values only when an event of interest is detected.

An event of interest can be defined in various ways. As an example, receiving an acoustic message is such an event. A particular or periodic value of the time-keeper, for example, every 60 seconds, can be an event which causes values to be saved. The series of processed vibration recordings can be examined to determine whether a vibration event of interest has occurred. As an example, consider the intensity of a processed vibration, A, present at time k which may be estimated by:

$$A ( k ) = {\sum }_{n = 1}^{N} \vert y ( n ) \vert / N$$

where |y(n)| represents the absolute value of the processed sample, y(n). The value of A(k) may be time-averaged at different times, k, using, for example a weighted averaging approach:

$$\overline{A} ( k ) = ( \frac{P - 1}{P} ) \overline{A} ( k - 1 ) + \frac{1}{P} A ( k )$$

A̅(k) is proportional to the average intensity at time k of the previous P vibration recordings in the sequence, y(n), n=1 . . . P, and P is a weight, typically ranging from 1 to 1000 , which controls how quickly the quantity A responds to a change in vibration level in y. If the condition:

$$A ( k ) > σ \overline{A} ( k )$$

is met at any time, k, then processed values such as y(n) or A(k) may be saved. The likelihood or saving—or the threshold for saving—is controlled by the value of σ, which typically ranges from 2 to 5.

At the end of the journey through the pipeline, the processor of the IFV stops recording vibration data and stores the value of the time-keeper. The condition to stop recording may be based on a pre-programmed value of the time-keeper, receiving an acoustic message, or some other event.

Data Downloading and Analysis

After the IFV has completed its journey, the IFV can be retrieved from the pipeline. The stored values in memory can be transferred to a computer via the communication link 940. The stored values may be analyzed using a software program executed by the computer.

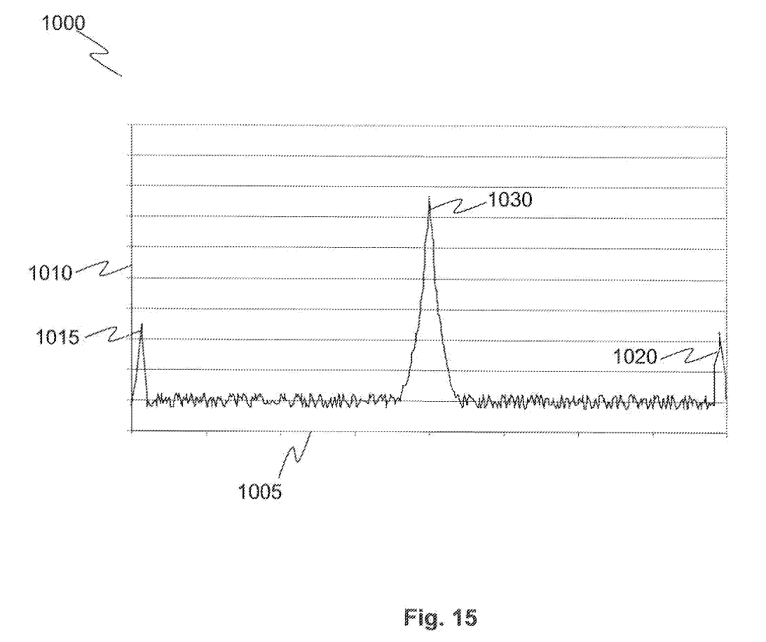

Referring to FIG. 15, in one implementation, the stored values are represented in a graph 1000. The horizontal axis of the graph 1005 may denote the index of the sequence of stored values, values of the time-keeper, or time or distance through the pipeline. The vertical axis 1010 of the graph represents a series of discrete stored values plotted along the horizontal axis. The stored values may represent intensity or some other processed value of the vibration recordings.

A stored value representing the start of the journey is marked on the graph 1015 and serves as a time stamp of the start of recording. Similarly, a stored value representing the end of the journey is marked on the graph 1020 and serves as a time stamp of the end of recording. An event of interest is indicated by a graphical feature 1030 showing a progressive rise in the amplitude of stored values, a maximum, and then a progressive decline in the amplitude of stored values. This event of interest may mark the passage of the IFV towards and then past a pipeline artifice, such as a pump, or an unexpected vibration source, such as a leak.

The location of events of interest can be determined from the graph by several means. A topographic map of the pipeline shows variations in altitude of the pipeline along its route. By comparing stored values of a tilt signal with a topographic map of the pipeline, values of the tilt signal, and hence values of the time-keeper of the IFV, can be matched with features of the topographic map. This allows knowledge of the location of the IFV at particular values of its time-keeper. Known vibration sources in the pipeline, such as pumps, can also be used to calibrate the value of the time-keeper with the distance through the pipeline from the start of the journey. Estimates of the velocity of the IFV can be readily made by timing the journey of the IFV between two known vibration sources. When no installed pipeline vibration sources are available, acoustic transmitters can be used for this purpose. The stored values of a tilt signal can be used to compensate for nonlinear effects of gravitational acceleration on the velocity of the IFV. Referring again to FIG. 15, with approximate knowledge of the velocity variations of the IFV, it is straightforward to find the absolute location of any event of interest using a combination of acoustic messages and interpolation along the time axis.

A number of implementations have been described. Nevertheless, it will be understood that various modifications may be made. Accordingly, other implementations are within the scope of the following claims.

What is claimed is:

1. A method of mapping vibrations in a pipeline, the method comprising:
launching a vehicle into the pipeline, the vehicle having known buoyancy, vibration sensing capabilities, a recording means, processing means, memory, a precision time-keeper, and a communication means;
recording and processing vibrations at programmed time intervals while the vehicle travels through the pipeline; and
analyzing the processed vibrations in order to locate vibration events in the pipeline.

2. The method of claim 1 wherein the vehicle is conveyed through the pipeline by the kinetic energy of fluid flow.

3. The method of claim 1 wherein the vehicle also includes a propulsion means, such as one or more motor-driven propellers.

4. The method of claim 1 wherein the launching step includes setting a value of the time-keeper of the vehicle.

5. The method of claim 1 wherein the buoyancy of the vehicle is set according to the weight of the fluid in the pipeline.

6. The method of claim 5 wherein the vehicle is made neutrally buoyant so as to travel at the center of flow in the pipeline.

7. The method of claim 5 wherein the buoyancy of the vehicle is set to be negative so as to travel at the top of the pipeline.

8. The method of claim 5 wherein the buoyancy of the vehicle is set to be positive so as to travel at the bottom of the pipeline.

9. The method of claim 1 wherein the vehicle is approximately a sphere so as to enable it to flow over or around any obstructions in the pipeline.

10. The method of claim 1 wherein the vehicle includes a passive guidance means arranged to direct fluid so as to steer the vehicle towards the center of the pipeline using only differences in fluid flow velocity between the center of flow and the wall of the pipeline.

11. The method of claim 1 wherein the vibration sensing includes mounting one or more vibration sensors to sense the vibrations present in the fluid around the vehicle.

12. The method of claim 1 wherein the vibration sensing capabilities include using gravitational acceleration to measure the tilt or inclination of the vehicle.

13. The method of claim 1 wherein the processing step includes computing a measure of the time-varying vibrations recorded in the fluid around the vehicle as it travels through the pipeline.

14. The method of claim 1 wherein the processing step includes storing the processed vibrations in the memory of the vehicle.

15. The method of claim 14 wherein the processed vibrations are stored in the memory of the vehicle after determination of an event of interest.

16. The method of claim 1 wherein the vibrations recorded from one or more sensors are used to cancel the effects of a vibration local to the vehicle in order to represent other components of the vibrations present in the fluid more accurately.

17. The method of claim 16 wherein the cancelled effect is the local vibration caused by a propeller of the vehicle.

18. The method of claim 16 wherein the cancelled effect is a particular vibration present in fluid in the pipeline, such as a vibration caused by a pump.

19. The method of claim 1 wherein the processing step includes estimating the velocity of the vehicle using vibrations sensed at one or more times.

20. The method is claim 1 wherein the recording step includes recording a message transmitted by an acoustic transmitter which is connected to the pipeline.

21. The method of claim 20 wherein the recorded message is interpreted as a synchronization event in order to register a known location in the pipeline at a particular value of the time-keeper.

22. The method of claim 1 wherein the retrieving step includes noting a value of the time-keeper at the approximate time of retrieval of the vehicle from the pipeline.

23. The method of claim 1 wherein the analyzing step includes using the recording times of the processed vibrations to determine a location of one or more vibration events in the pipeline.

24. The method of claim 1 wherein a pipeline location is determined using a measure of the recording time of a processed vibration relative to the approximate times of the launch and retrieval of the vehicle.

25. The method of claim 23 wherein a location is determined using one or more measures of the recording times of processed vibrations and one or more measures of the velocity of the vehicle.

26. The method of claim 23 wherein a location is determined using one or more measures of the recording times of processed vibrations and one or more measures of the inclination of the vehicle in order to match the vibration to a topographical feature of the pipeline.

27. The method of claim 1 wherein the launching step includes launching two or more vehicles at approximately known times apart in order that the recording times of processed vibrations made my multiple vehicles may be compared so as to obtain an improved measure of the location of a vibration event.

28. The method of claim 1 wherein the vehicle includes a means of converting the energy associated with the motion of the vehicle into electrical energy so as to reduce the need for a power source.

29. The method of claim 28 wherein the conversion of energy is achieved using a magnet and coil.

30. The method of claim 28 wherein the conversion of energy is achieved using a mass and piezoelectric material.

31. A method of mapping vibrations in a pipeline, the method comprising:
launching a vehicle into the pipeline, the vehicle including a vibration sensor, a data recorder, a processor and a time-keeper;
recording vibrations at programmed time intervals while the vehicle travels through the pipeline;
retrieving the vehicle from the pipeline; and
analyzing the recorded vibrations in order to locate vibration events in the pipeline.

32. A vehicle for use in mapping vibrations in a pipeline, the vehicle comprising:
a housing configured to be launched into the pipeline and to travel in the pipeline; and
a vibration sensor, a data recorder, a processor and a time-keeper contained within for housing,
wherein the processor is configured to record vibrations at programmed time intervals while the vehicle travels through the pipeline.

33. The vehicle of claim 32, further comprising a passive guidance system arranged to direct fluid so as to steer the vehicle towards a center of the pipeline using only differences in fluid flow velocity between the center of flow and a wall of the pipeline.

34. The vehicle of claim 33, wherein the passive guidance system comprises a flow-directing tube configured to accelerate flow passing through the tube.

35. The vehicle of claim 33, wherein the passive guidance system comprises a flow-directing slot configured to cause a turning force which causes the vehicle to spin while the vehicle travels through the pipeline.

36. The vehicles of claim 32, further comprising a propulsion mechanism to propel the vehicle through the pipeline.

37. The vehicle of claim 32, wherein the vehicle is set to be neutrally buoyant so as to travel at a center of flow in the pipeline.

38. The vehicle of claim 32, wherein the processor is configured to cancel effects of vibrations local to the vehicle.

39. The vehicle of claim 32, further comprising an energy gathering mechanism to generate electrical power by converting kinetic energy associated with the motion of the vehicle.
